(19) United States
(12) Patent Application Publication
(10) Pub. No.: US 2011/0073412 A1
(43) Pub. Date: Mar. 31, 2011

(54) AXIAL FAN COMPACT BEARING VISCOUS PUMP

(75) Inventors: Philip Hoyle, Wooster, OH (US); Glenn Huebscher, Stow, OH (US)

(73) Assignee: TLT-BABCOCK, INC., Akron, OH (US)

(21) Appl. No.: 12/568,098

(22) Filed: Sep. 28, 2009

(51) Int. Cl. F16N 13/10

(52) U.S. Cl. 184/27.1

(57) ABSTRACT

Axial fan compact bearing viscous pump having two spaced apart bearing housings and a bearing supported within each bearing housing. A shaft is supported within each bearing housing. The shaft has two oil disks, each bearing having an oil disk proximate thereto. The portion of each bearing housing fitting about a respective one of the oil disks forms a viscous pump housing. The viscous pump housing has an oil inlet and an oil outlet. The oil outlet is spaced from the oil inlet. On an inner periphery of the viscous pump housing, an oil channel in an inner periphery facing an outer periphery of the one of the oil disks extends only partway around the viscous pump housing inner periphery. The oil channel extends from the oil inlet in the direction of rotation of the shaft to a point beyond the oil outlet.

### BACKGROUND AND SUMMARY OF THE INVENTION

The invention relates to a compact bearing for axial fans. More particularly, the invention relates a viscous pump to provide pumped lubricating fluid to bearings.

Conventional lubrication systems for large rotating equipment such as turbine-generators, axial fans, etc., have employed a central pump with pipes leading to the various bearings to provide a flow of lubricating oil to the bearings. There has been a need for a simple means to lubricate each bearing separately without the need for extensive piping to and from a central pump unit.

The foregoing illustrates limitations known to exist in conventional lubricating systems. Thus, it is apparent that it would be advantageous to provide an alternative directed to overcoming one or more of the limitations set forth above. Accordingly, a suitable alternative is provided including features more fully disclosed hereinafter.

In one embodiment, an axial fan compact bearing viscous pump is provided having: a shaft supported, the shaft rotating in a direction of rotation; an oil disk on the shaft; a viscous pump housing fitting about the oil disk and having an oil inlet therein, an oil outlet therein, the oil outlet being spaced from the oil inlet; the viscous pump housing having an oil channel in an inner periphery facing an outer periphery of the oil disk, the oil channel extending only partway around the viscous pump housing inner periphery, the oil channel extending from the oil inlet in the direction of rotation to a point beyond the oil exit.

In a further embodiment, two viscous pumps having a common shaft are provided. Further, axial fans can be connected to the ends of the common shaft. In yet a further embodiment, an axial fan compact bearing viscous pump is provided having: two spaced apart bearing housings; a bearing supported within each bearing housing; a shaft supported within each bearing housing, the shaft rotating in a direction of rotation; two oil disks on the shaft, each bearing having an oil disk proximate thereto; a portion of each bearing housing fitting about a respective one of the oil disks and forming a viscous pump housing, the viscous pump housing having an oil inlet therein, an oil outlet therein, the oil outlet being spaced from the oil inlet; the viscous pump housing having an oil channel in an inner periphery facing an outer periphery of the one of the oil disks, the oil channel extending only partway around the viscous pump housing inner periphery, the oil channel extending from the oil inlet in the direction of rotation to a point beyond the oil exit, the viscous pump housing including an oil sump containing oil, the level of the oil at the oil inlet extending above the oil channel adjacent the oil inlet, the bearing housing having an oil conduit extending from the oil inlet to the bearing.

The compact bearing may also have axial fans connected to the ends of the common shaft.

This and other aspects will become apparent from the following detailed description of the invention when considered in conjunction with the accompanying drawing figures.

### BRIEF DESCRIPTION OF THE DRAWING FIGURES

FIG. 1 shows a cross section of an axial fan compact bearing viscous pump;

FIG. 2 shows a cross-section of the axial fan compact bearing viscous pump shown in FIG. 1, taken on line 2-2.

FIG. 3A is an enlarged detail of the oil outlet of the axial fan compact bearing viscous pump shown in FIGS. 1 and 2;

FIG. 3B is an enlarged detail of the oil inlet of the axial fan compact bearing viscous pump shown in FIGS. 1 and 2;

FIG. 3C is a second enlarged detail of the oil outlet of the axial fan compact bearing viscous pump shown in FIGS. 1 and 2;

FIG. 3D is an enlarged detail of the oil sump of the axial fan compact bearing viscous pump shown in FIGS. 1 and 2;

FIG. 3E is an enlarged detail of the oil channel of the axial fan compact bearing viscous pump shown in FIGS. 1 and 2;

FIG. 4 is a cross section of a compact bearing showing the viscous pumps of FIG. 1; and

FIG. 5 is a side view of the compact bearing shown in FIG. 4 with axial fans attached to outboard ends of the shaft.

### DETAILED DESCRIPTION

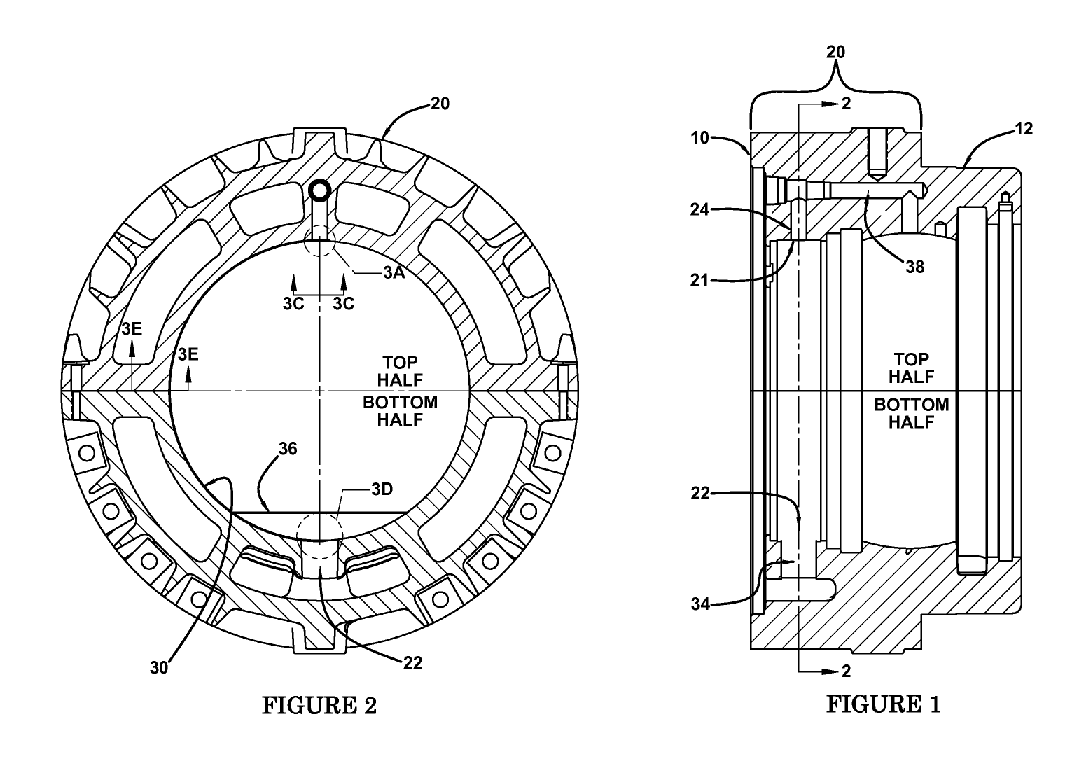

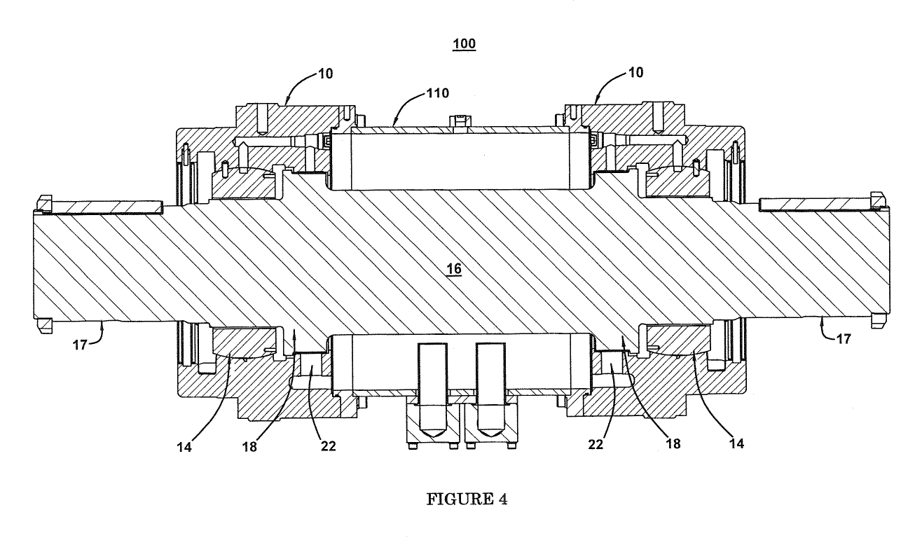

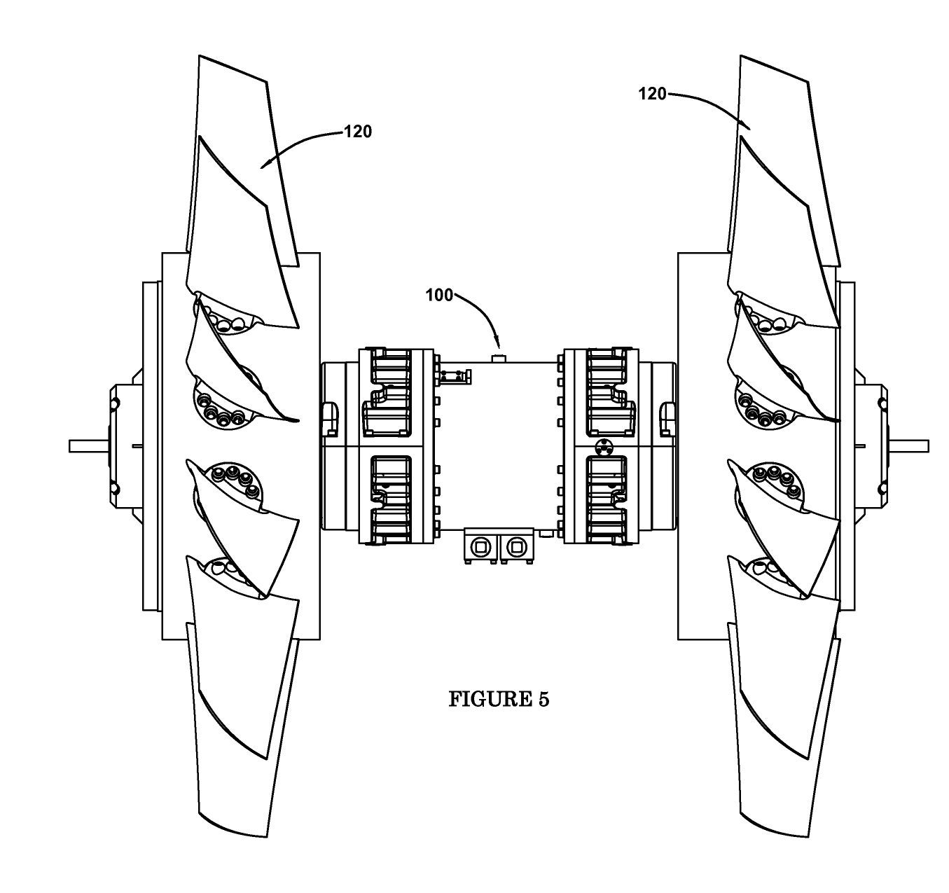

FIG. 4 shows one preferred embodiment of an axial fan compact bearing 100. The axial fan compact bearing 100 includes two viscous pumps 10. As shown in FIG. 1, each viscous pump 10 has a bearing housing 12. A bearing 14 is fitted within a first part of the bearing housing 12. A shaft 16 is supported by bearing 14. An oil disk 18 is fitted on the shaft 16 and is positioned adjacent the bearing 14. The oil disk 18 may be a separate component attached to the shaft 16 or may be formed as part of the shaft 16. In a preferred design, the oil disk 18 is about 17 inches in diameter.

In an alternate embodiment, the axial fan compact bearing 100 can consist of a single viscous pump 10. Also, in an alternate embodiment, the compact bearing viscous pump 10 is separate from the bearing 14 where both the viscous pump 10 and bearing 14 each have respective housings. In a preferred embodiment, as shown in the Figures, a single housing is used for both the bearing and the viscous pump.

A portion 20 of the bearing housing 12 fits about the oil disk 18 defining a viscous pump housing. The clearance between an inner periphery 21 of the viscous pump housing 20 and the oil disk is preferably between 0.004 inches and 0.020 inches. An oil inlet 22 is positioned at a lower portion of the viscous pump housing 20. Below the oil inlet 22 is an oil sump 34. In one preferred embodiment shown in the Figures, an oil outlet 24 is positioned at the top of the viscous pump housing 20. The oil outlet 24 may be positioned at other locations, such as 270 degrees clockwise or 100 degrees clockwise from the oil inlet 22.

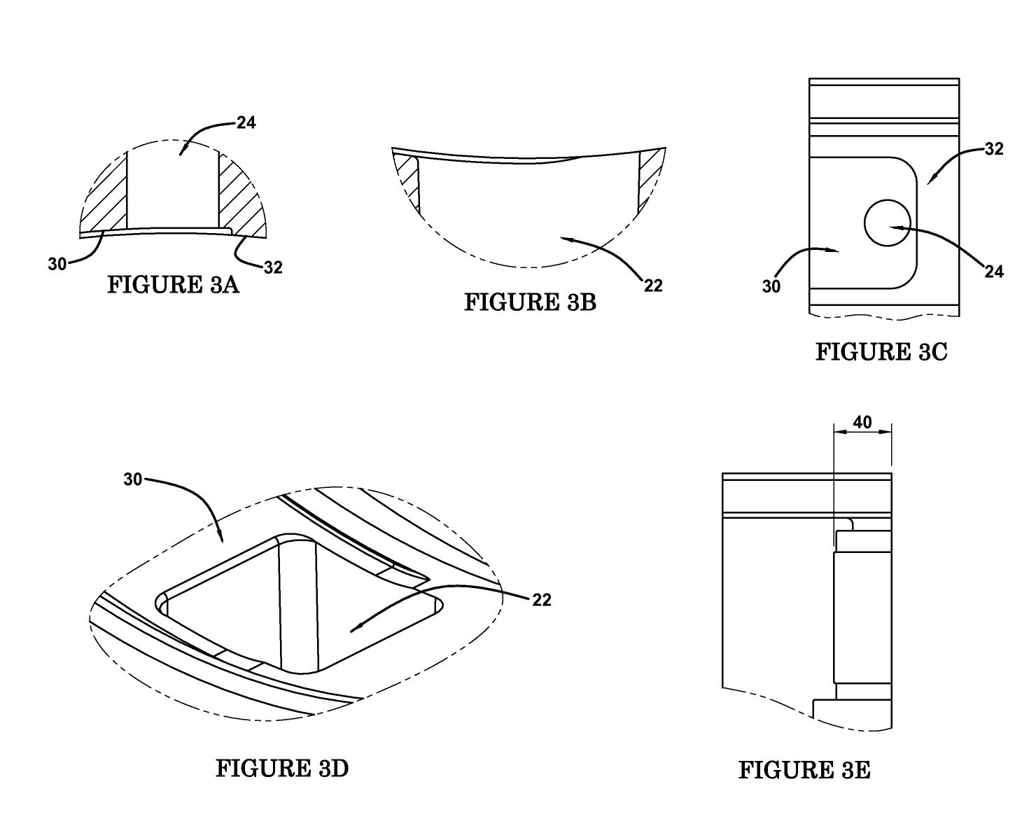

An oil channel 30 is formed in the inner periphery 21 of the viscous pump housing 20 and extends in the direction of rotation, as shown in FIG. 2, (this is clockwise in FIG. 2) from the oil inlet 22 to the oil outlet 24. FIGS. 3B and 3D show details of the oil inlet 22 and the oil channel 30. In a preferred embodiment, the depth 40 (see FIG. 3E) of the oil channel 30 is about 0.03 inches to 0.150 inches. An oil dam 32 is positioned beyond (in the direction of rotation) of the oil outlet 24 as shown in FIGS. 3A and 3C. In the preferred embodiment, no scraper in the oil outlet 24 is used to prevent the entrained oil from being transported past the oil outlet 24. In a preferred embodiment, the oil channel 30 extends just beyond the oil outlet 24, as shown in FIGS. 3A and 3C.

The viscous pump 10 is filled with oil such that the oil level 36 rises above the oil inlet 22, as shown in FIG. 2.

The beginning of the oil channel 30 is below the oil level 36, as shown in FIG. 3B. As the shaft 16, and oil disk 18 thereon, rotates, oil is entrained in the clearance between the oil disk 18 and the viscous pump housing 20. The entrained oil flows clockwise (the direction of rotation) in the oil channel 30 to the oil outlet 24. From the oil outlet 24, the oil is then conveyed in conduits, such as oil conduit 38, to bearing 14 to lubricate bearing 14. Oil then flows out of the bearing 14 and back to the oil sump 34. As needed, the oil may pass through filters and coolers before being returned to the oil sump 34.

The oil channel 30 contraction occurs at a point near the oil outlet 24. The oil channel 30 expansion occurs at a point below the oil level 36. As a result, there is no negative pressure gradient (suction) at the oil channel expansion to either excessively draw oil or gas/oil into or across the circumferential gap formed by the oil channel contraction and expansion. One purpose of this arrangement of oil channel contraction and expansion is to reduce or eliminate adverse pressure gradients that can pull fluids into the working channel except within the oil sump.

Depending on system requirements, oil from the oil exit 24 may also be conveyed to other components, not shown, such as fan bearings, motor bearings, coolers, filters, etc.

In a preferred embodiment, the oil flow from viscous pump 10 is sufficient to lubricate bearing 14 in the event oil flow from an external lubricating system fails to protect bearing 14 while the system is shut down. In a further preferred embodiment, the oil flow from viscous pump 10 provides sufficient lubricating oil to bearing 14 so that no external lubricating system is required.

In one preferred embodiment, as shown in FIG. 4, the compact bearings has two viscous pumps 10 fitted about a single continuous shaft 16. The viscous pumps 10 are axially spaced apart with a shaft housing 110 extending between the viscous pumps 10 and surrounding shaft 16. Shaft 16 extends beyond the outboard ends 17 of the bearing housings 12 so that axial fans 120 can be attached to shaft 16.

Although two viscous pumps 10 are shown in FIG. 4, a single viscous pump 10 may be used by itself in other applications.

While certain embodiments have been described in the present application, it will be understood by those skilled in the art that various changes may be made and equivalents may be substituted without departing from the scope of the claimed invention. In addition, many modifications may be made to adapt a particular situation or material to the teachings of the claimed invention without departing from its scope. Therefore, it is intended that the claimed invention not be limited to the particular embodiments disclosed, but that the claimed invention will include all embodiments falling within the scope of the appended claims.

Having described the invention, what is claimed is:

1. A viscous pump comprising:
a shaft, the shaft rotating in a direction of rotation;
an oil disk on the shaft;
a viscous pump housing fitting about the oil disk and having an oil inlet therein, and an oil outlet therein, the oil outlet being spaced from the oil inlet;
the viscous pump housing having an oil channel in an inner periphery facing an outer periphery of the oil disk, the oil channel extending only partway around the viscous pump housing inner periphery, the oil channel extending from the oil inlet in the direction of rotation to a point beyond the oil outlet.

2. The viscous pump according to claim 1, wherein the oil outlet is opposite the oil inlet.

3. The viscous pump according to claim 1, wherein the oil outlet is free of any scraper.

4. The viscous pump according to claim 1, wherein the viscous pump housing includes an oil sump containing oil, the level of the oil at the oil inlet extending above the oil channel adjacent the oil inlet.

5. The viscous pump according to claim 1, further comprising:
a bearing housing;
a bearing supporting within the bearing housing;
the shaft being supported by the bearing.

6. The viscous pump according to claim 5, wherein the bearing housing has an oil conduit extending from the oil inlet to the bearing.

7. The viscous pump according to claim 6, wherein a portion of the bearing housing forms the viscous pump housing.

8. In combination:
a first viscous pump according to claim 7;
a second viscous pump according to claim 7;
wherein the shaft of the first viscous pump forms a continuous shaft with the shaft of the second viscous pump,
the first viscous pump being axially spaced from the second viscous pump.

9. The combination according to claim 8, further comprising:
an axial fan being attached to each end of the continuous shaft.

10. A viscous pump comprising:
a bearing housing;
a bearing supported within the bearing housing;
a shaft supported within the bearing housing, the shaft rotating in a direction of rotation;
an oil disk on the shaft;
a portion of the bearing housing fitting about the oil disk forming a viscous pump housing, the viscous pump housing having an oil inlet therein, an oil outlet therein, the oil outlet being spaced from the oil inlet;
the viscous pump housing having an oil channel in an inner periphery facing an outer periphery of the oil disk, the oil channel extending only partway around the viscous pump housing inner periphery, the oil channel extending from the oil inlet in the direction of rotation to a point beyond the oil outlet, the viscous pump housing including an oil sump containing oil, the level of the oil at the oil inlet extending above the oil channel adjacent the oil inlet,
the oil outlet being free of any scraper,
the bearing housing having an oil conduit extending from the oil inlet to the bearing.

11. The viscous pump according to claim 10, wherein the oil outlet is opposite the oil inlet.

12. An axial fan compact bearing viscous pump comprising:
two spaced apart bearing housings;
a bearing supported within each bearing housing;
a shaft supported within each bearing housing, the shaft rotating in a direction of rotation;
two oil disks on the shaft, each bearing having an oil disk proximate thereto;
a portion of each bearing housing fitting about a respective one of the oil disks and forming a viscous pump housing, the viscous pump housing having an oil inlet therein, an oil outlet therein, the oil outlet being spaced from the oil inlet;
the viscous pump housing having an oil channel in an inner periphery facing an outer periphery of the one of the oil disks, the oil channel extending only partway around the viscous pump housing inner periphery, the oil channel extending from the oil inlet in the direction of rotation to a point beyond the oil outlet,
the viscous pump housing including an oil sump containing oil, the level of the oil at the oil inlet extending above the oil channel adjacent the oil inlet,
each bearing housing having an oil conduit extending from the oil inlet to the bearing.

13. The axial fan compact bearing viscous pump according to claim 12, further comprising:
a shaft housing surrounding the shaft and extending from one bearing housing to the other bearing housing.

14. In combination:
the axial fan compact bearing viscous pump according to claim 12;
a first axial fan attached to a first end of the shaft; and
a second axial fan attached to a second end of the shaft.
